(19) United States
(12) Patent Application Publication
(10) Pub. No.: US 2025/0028759 A1
(43) Pub. Date: Jan. 23, 2025

(54) User Interface Framework for Enhancing Content with Language Model Interactions

(71) Applicant: ServiceNow, Inc., Santa Clara, CA (US)

(72) Inventors: Rita Maria Castillo, San Diego, CA (US); Troy Azmoon, San Diego, CA (US)

(21) Appl. No.: 18/768,340

(22) Filed: Jul. 10, 2024

Related U.S. Application Data
(60) Provisional application No. 63/527,618, filed on Jul. 19, 2023.

(51) Int. Cl. G06F 16/838; G06F 16/332; G06F 16/81

(52) U.S. Cl. CPC G06F 16/838; G06F 16/3329; G06F 16/81

(57) ABSTRACT

An example may involve receiving a request to generate a user interface component, wherein the request indicates data usable to populate the user interface component; generating a prompt for a natural language model based on the request and the data; receiving, from the natural language model, a representation of the user interface component based on the prompt; and providing the representation of the user interface component for display.

### CROSS-REFERENCE TO RELATED APPLICATION

This application claims priority to U.S. provisional patent application No. 63/527,618, filed Jul. 19, 2023, which is hereby incorporated by reference in its entirety.

### BACKGROUND

User interface design can be an inefficient and time-consuming process. Each screen of a user interface may include multiple components, each of which may be configurable to display different information in various ways. Typically, each component would need to be specifically programmed or designed to be able to display the desired custom output. As a consequence, the user interface design and development process can take weeks or months.

Furthermore, many user interfaces lack contextual support. These user interfaces merely present information to the user with little or no identifying or displaying of relevant or related content. A large, multi-application computing platform may have access to such information but providing and keeping this display updated and contextually relevant in the presence of changes to the user interface can be challenging. As a result, users often open multiple windows or browser tabs, one or more per application, in order to cross-reference potentially relevant information between applications. Not only is this approach unreliable, but it also makes heavy use of computing resources (e.g., processing, memory, and/or network capacity). Notably, these windows or tabs can consume a significant amount of memory on a client device.

### SUMMARY

Various implementations disclosed herein include user interfaces and techniques for developing and generating user interfaces in which a component thereof can be specified by way of natural language. Such specifications can be provided to a natural language model that is configured to respond with a representation of the requested component. This component can be modified, also by way of interactions with the natural language model, as needed. Then, it can be placed (e.g., dragged and dropped) into the desired location within the user interface. Additionally, components from the user interface can be provided to the natural language model for purposes of explanation.

These implementations may also include user interfaces for a dialog between two or more users and/or virtual agents. Such user interfaces may maintain a dynamically-updated list of information relevant to the messages within the dialog (e.g., links to items in a workflow, links to articles, and/or suggested messages). The information in this list may be determined based on providing one or more of the messages displayed in the dialog to a natural language model and receiving a response containing related data. Thus, the list may be modified as the dialog progresses and/or a user scrolls through the dialog.

Accordingly, a first example embodiment may involve receiving a request to generate a user interface component, wherein the request indicates data usable to populate the user interface component; generating a prompt for a natural language model based on the request and the data; receiving, from the natural language model, a representation of the user interface component based on the prompt; and providing the representation of the user interface component for display.

A second example embodiment may involve providing, for display, a user interface including a plurality of user interface components, wherein the plurality of user interface components includes a dialog component; receiving, via the dialog component, a request to generate a further user interface component; obtaining a representation of the further user interface component based on the request; and providing, for display in the dialog component, the representation of the further user interface component.

A third example embodiment may involve receiving, via a user interface, a message of a dialog; generating, based on the message, a prompt for a natural language model; providing the prompt to the natural language model, and receiving a representation of suggested content in response; and providing, for display in the user interface, the representation of suggested content, wherein the representation of suggested content is updatable based on messages displayed in the dialog.

A fourth example embodiment may involve providing, for display, a user interface including a dialog and a listing of information relating to the dialog; receiving, via the dialog, a message; obtaining, based on the message, a representation of suggested content; and adding the representation of the suggested content to the listing of information, wherein the listing of information is updatable based on messages displayed in the dialog.

A fifth example embodiment may involve a non-transitory computer-readable medium, having stored thereon program instructions that, upon execution by a computing system, cause the computing system to perform operations in accordance with the first, second, third, and/or fourth example embodiment.

In a sixth example embodiment, a computing system may include at least one processor, as well as memory and program instructions. The program instructions may be stored in the memory, and upon execution by the at least one processor, cause the computing system to perform operations in accordance with the first, second, third, and/or fourth example embodiment.

In a seventh example embodiment, a system may include various means for carrying out each of the operations of the first, second, third, and/or fourth example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts integration of an LLM service and a remote network management platform, in accordance with example embodiments.

FIG. 7 depicts an architecture for skill-based LLM prompt generation, in accordance with example embodiments.

FIGS. 8A, 8B, and 8C depict a graphical user interface, the components thereof, and a tree-like representation thereof, in accordance with example embodiments.

FIG. 9A defines a dropdown menu component in XML format, in accordance with example embodiments.

FIG. 9B defines a bar chart component in XML format, in accordance with example embodiments.

FIG. 9C shows a rendering of the bar chart defined by the component XML of FIG. 9B, in accordance with example embodiments.

FIGS. 10A, 10B, 10C, 10D, and 10E depict interactive graphical user interfaces with natural language support, in accordance with example embodiments.

FIGS. 11A, 11B, 11C, 11D, and 11E depict interactive chat dialogs with natural language support, in accordance with example embodiments.

FIG. 12A, 12B, 12C, and 12D are flow charts, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Example Technical Improvements

These embodiments provide technical solutions to technical problems. One technical problem being solved is graphical user interface design, development, and modification. In practice, this is problematic because previous techniques take weeks or months to develop components and layouts that convey meaning to user in the desired fashion.

In particular, components had to be coded in a programming language supported by the computing platform (e.g., HTML and JAVASCRIPT®) that is intended to provide and/or display the graphical user interface, with appropriate database queries and component attributes (e.g., colors and arrangements) specified. However, these techniques do not scale and often result in graphical user interfaces with inconsistent behavior and appearance across components and screens. Moreover, the previous techniques rely on subjective decisions and experiences of individual designers and programmers, which leads to wildly varying outcomes from instance to instance. Thus, previous techniques did little if anything to address rapid graphical user interface development.

The embodiments herein overcome these limitations by integrating user interfaces and user interface builder tools with natural language models, such as large language models (LLMs). In this manner, graphical user interface development can be accomplished in a more accurate and robust fashion. This results in several advantages. First, components can be generated by a natural language model in accordance with a consistent design, and these components can be easily modified and combined with other components. Second, component generated by a natural language model can be dragged and dropped into a screen or panel of a user interface in a low-code/no-code fashion, thereby reducing design time and often not requiring any programming. Third, components can be provided to a natural language model so that the natural language model can generate a plain language description of what the components mean to an end user.

Another technical problem being solved is providing contextually relevant information in a context panel or sidebar of a conversational interface without requiring excessive use of a natural language model. Thus, the embodiments herein may use a natural language model to provide contextual information to display along with the conversational interface. However, as the user may scroll up and down in a dialog displayed in this conversational interface, multiple redundant natural language model queries would be made.

The embodiments herein overcome these inefficiencies by maintaining a cache of mappings between displayed messages in the dialog and contextually relevant information (e.g., links to articles, links to incidents, links to orders, and/or suggested messages). In this manner, the content panel can be updated as the user scrolls without querying a natural language model. These embodiments also avoid the user having to open multiple windows or browser tabs (e.g., one or more per application) in order to cross-reference potentially relevant information between applications. Not only is this multi-window/multi-tab approach unreliable, but is also makes heavy use of computing resources (e.g., processing, memory, and/or network capacity). Notably, these windows or tabs can consume a significant amount of memory on a client device. Therefore, these embodiments herein provide an improvement to a computing system by reducing resource utilization.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

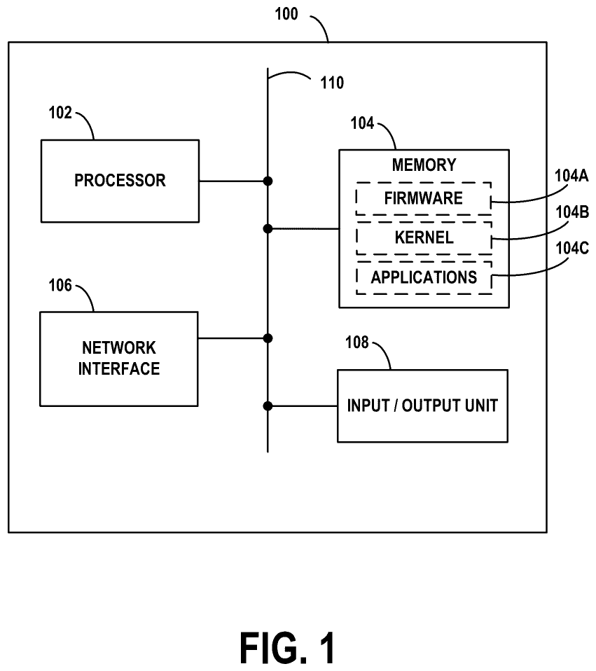

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

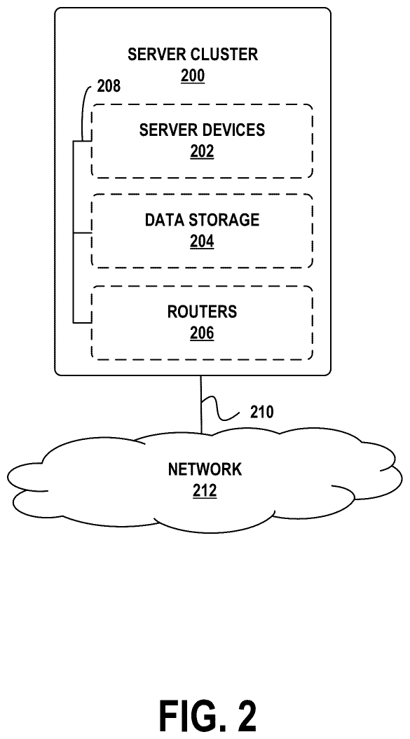

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

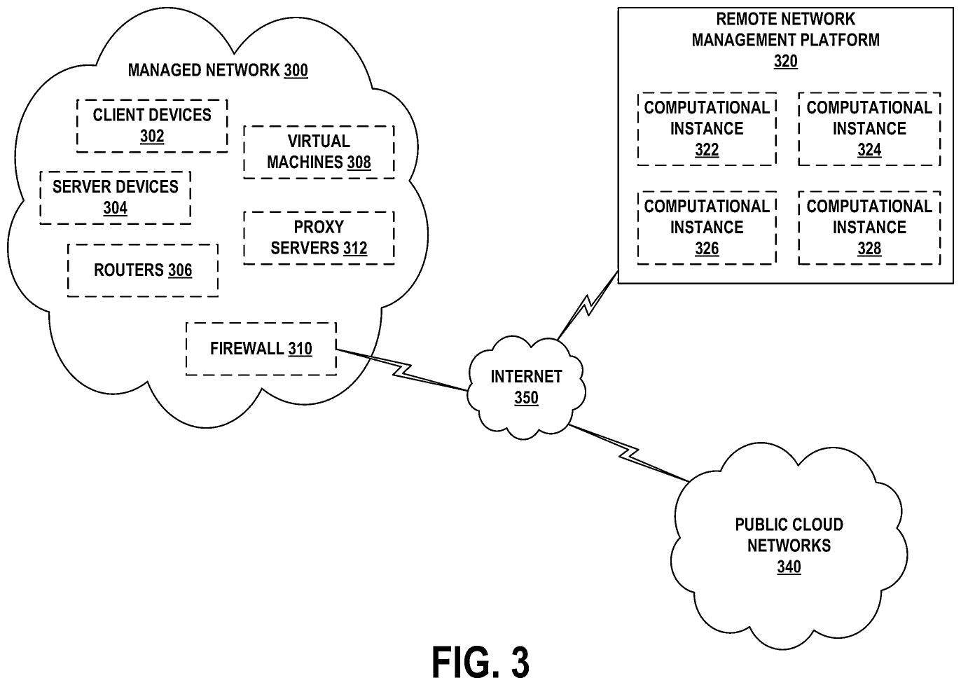

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

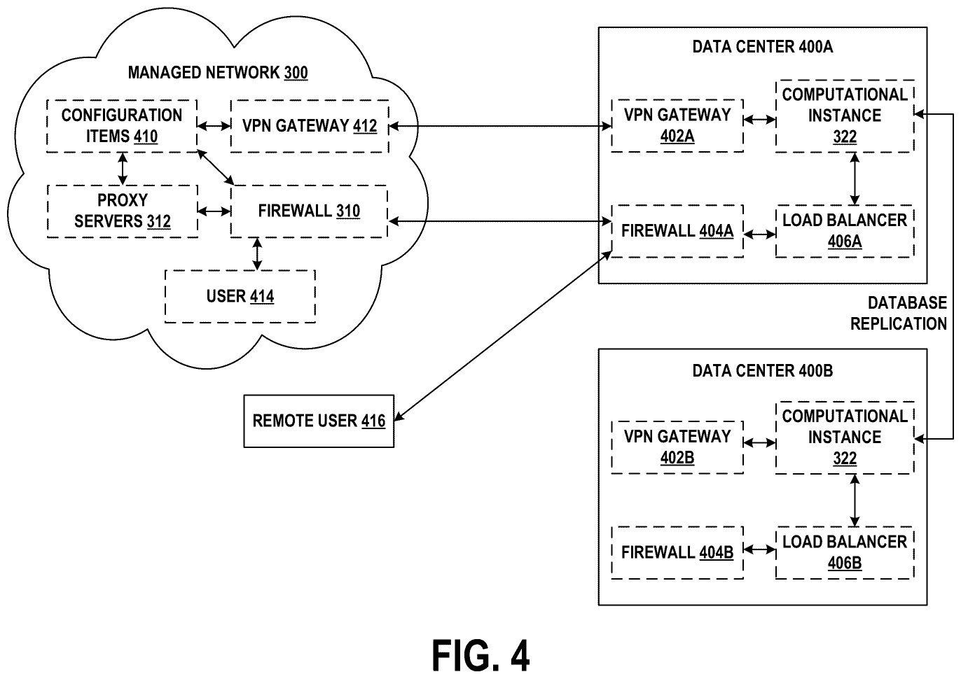

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

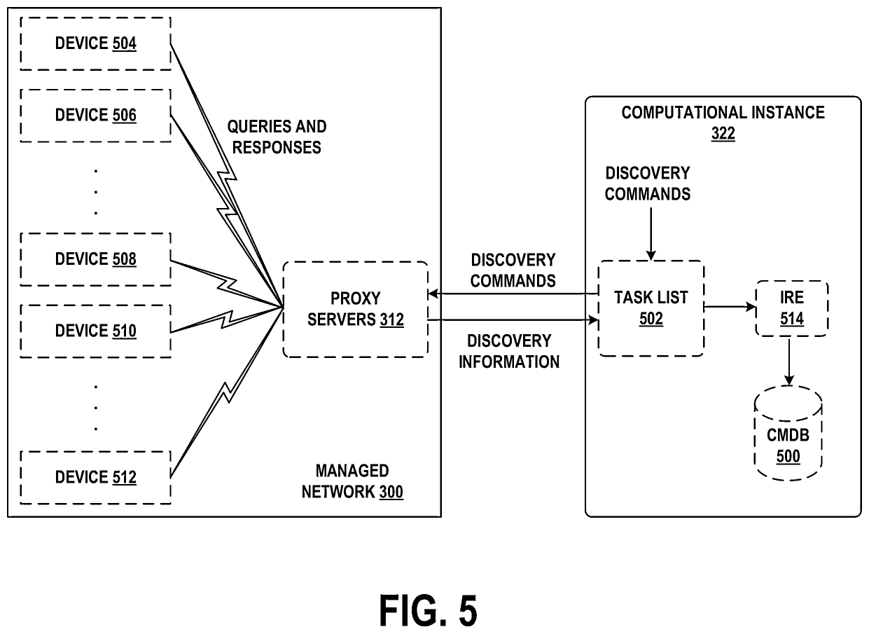

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces are briefly described below to provide context for example embodiments of software that has user interfaces that could be enhanced by natural language model interactions.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code/no-code approach to designing intuitive graphical user interfaces, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently-asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### VIII. LLM Integration

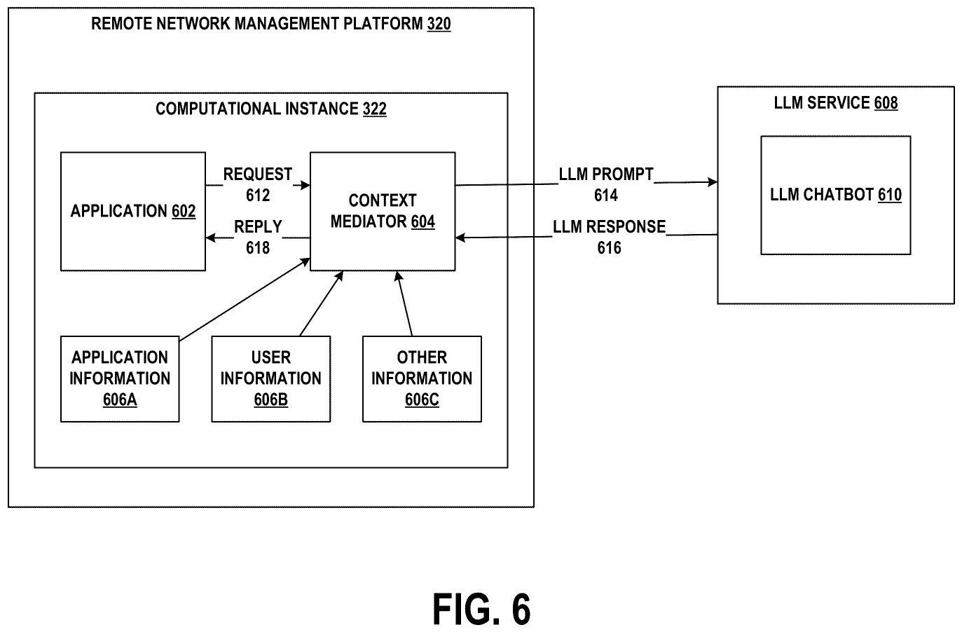

FIG. 6 depicts integration of an LLM with remote network management platform 320. Remote network management platform 320 includes computational instance 322 (in addition to other computational instances). Computational instance 322, in turn, provides the infrastructure for application 602 (in addition to other applications) to execute. Also executable on computational instance 322 is context mediator 604.

Context mediator 604 may be a software application that serves as an intelligent proxy between application 602 and LLM service 608. Notably, a user of application 602 may submit request 612. Request 612 may be a textual request relating to how the user is interacting with application 602. For example, if application 602 is an incident management application, request 612 might be “Display all unresolved high priority incidents.” On the other hand, if application 602 is a user interface builder application, request 612 might be “Generate a chart of average time to resolve high priority incidents.”

From request 612, context mediator 604 may generate LLM prompt 614. In doing so, context mediator 604 may use contextual information stored on or available to computational instance 322. This contextual information may include, but is not limited to, application information 606A, user information 606B, and other information 606C. Application information 606A may include contextual information relating to application 602, such the database tables it uses, their fields, values that can be stored in these fields, as well as general application state. User information 606B may include the user's personal information (e.g., name, postal address, phone number, and/or email address), userid, role and permissions on computational instance 322, historical information (e.g., previous prompts and user preferences), and so on. Other information 606C may include any additional information that computational instance 322 may access that could be relevant to generating LLM prompt 614.

Context mediator 604 may be pre-configured with a number of canonical prompts that can be modified based on request 612, application information 606A, user information 606B, and/or other information 606C. An example canonical prompt might be “Provide an SQL query to obtain all incidents from a database table with the following schema [SCHEMA] that matches the following criteria [CRITERIA].” The placeholders [SCHEMA] and [CRITERIA] are replaced by contextual information, and then the prompt is sent to LLM service 608 as LLM prompt 614. Context mediator 604 may also have the ability to take into account any form of textual metadata when generating LLM prompt 614.

If context mediator 604 does not have enough information to generate LLM prompt 614, it may request any missing information from the user. For example, context moderator 604 may ask the user “When you say ‘high priority incidents’ do you mean P1 incidents?” or “Do you want a bar chart or pie chart?” The responses to these questions may be used along with request 612 to generate LLM prompt 614. Alternatively, LLM prompt 614 may be constructed from the information initially provided and LLM service 608 may respond (via context mediator 604) with the questions for the user. Notably, context mediator 604 may include a virtual agent interface to facilitate this interaction with the user.

LLM service 608 may be a third-party service remotely accessible to computational instance 322 by way of an API. Alternatively, LLM service 608 could be operable on remote network management platform 320. LLM service 608 may include LLM chatbot 610, an application that receives LLM prompt 614 and generates LLM response 616 for transmission to context mediator 604. Notably, LLM chatbot 610 may operate on textual input and generate textual output. However, LLM chatbot 610 may be able to receive and understand certain types of graphical or audio input as well as produce graphical or audio output. For example, if LLM chatbot 610 is asked to generate a graph, LLM chatbot 610 may generate the graph in a textual form (e.g., using JSON, XML, HTML, YAML, or GraphML) or a graphical form (e.g., a PNG or JPEG file).

LLMs are machine-learning constructs that can be trained on vast amounts of textual data, such as books, articles, and websites, to learn patterns and relationships between words and phrases. Some examples of LLMs include GPT-4, bidirectional encoder representations from transformers (BERT), language model for dialogue applications (LaMDA), and Transformer-XL. LLMs can perform a wide range of natural language processing tasks, such as summarization, text classification, question answering, and language translation. These LLMs also have the ability to create coherent and human-like text. Many LLMs are based on the transformer architecture, which employs self-attention when considering different parts of an input sequence (e.g., of tokens such as words) to compute a representation of each element in the sequence taking long-range dependence between elements into account. Herein, an LLM may also be referred to as a “natural language model” or a “language processing model”.

The operation of an LLM involves layers of interconnected processing units, known as neurons, which collectively form a deep neural network. This network can be trained on the datasets noted above, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

Furthermore, an LLM can be fine-tuned for specific applications or tasks after its initial training. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

As a result of receiving LLM response 616 from LLM service 608 (e.g., from LLM chatbot 610), context mediator 604 may use and/or modify the content of LLM response 616 in order to generate reply 618. For instance, LLM response 616 might include an SQL query. In this case, context generator 604 may execute the SQL query on an appropriate database, then provide the results of the query in an appropriate format to the user in reply 618.

In line with these features, LLM service 608 may be or include a specialized LLM trained specifically for generating responses that are contextually relevant to remote network management platform 320. For example, such a specialized LLM may be trained on associations between natural language, user interface specifications (e.g., in the form of source code or metadata), database schema specifications (e.g., in the form SQL-based tables or metadata), and/or other source code of remote network management platform 320.

In some embodiments, the operations of context mediator 604 may be governed by a finite set of pre-defined skills. These skills may include techniques for interacting with databases, third-party tools, different types of users, and for different types of applications. Thus, the operations of context mediator 604 may involve, for requests and LLM responses, first determining the appropriate skill to invoke based on context, and then invoking that skill.

In this manner, the user does not have to provide a potentially complex and extensive amount of information to an LLM directly. Instead, context mediator 604 effectively translates the user's relatively simple requests into specific LLM prompts that are more likely to result in LLM responses that are relevant to the user's needs. Further, context mediator 604 can modify the LLM responses so that they are more user friendly and/or in a desired form.

The skills may be specific software modules or capabilities built into context mediator 604 that are configured to determine the intent of a request, based on the request, application information 606A, user information 606B, and/or other information 606C. With an intent identified, an appropriate skill may be selected. Examples of skills may be chart generation, chart interpretation, chart modification, IT support queries (possibly a number of specific types), application-specific queries (e.g., questions regarding the use or configuration of an application), incident management, case management, problem management, order management, and so on. In some cases, multiple skills may be employed in response to a single request or a series of requests.

Once the skill is identified, it can be used to assist with various types of user interaction. As needed, the skill may generate skill-specific LLM prompts and transmit these prompts to LLM service 608. The skill may also be configured to receive LLM responses from LLM service 608 and generate appropriate replies that can be provided to application 602.

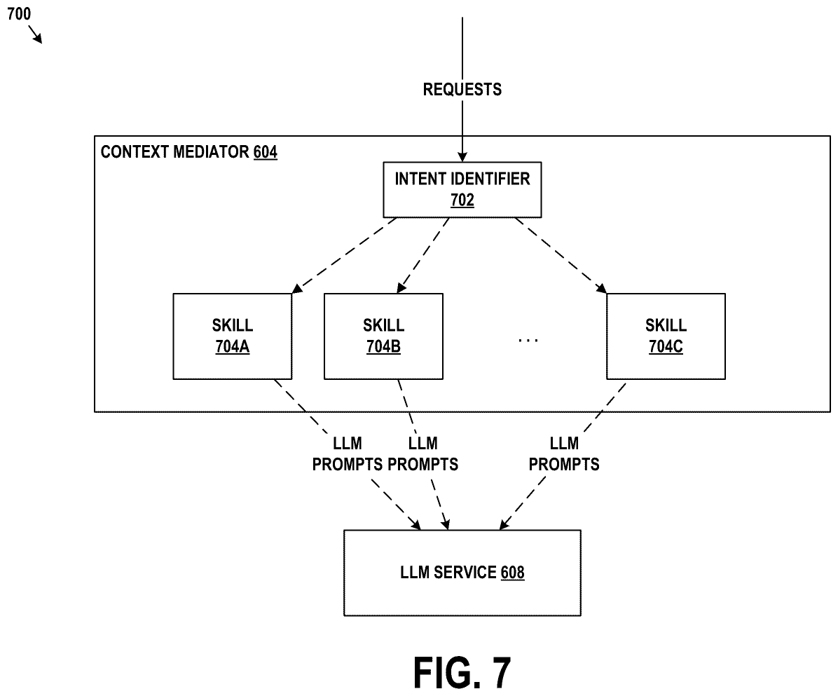

FIG. 7 depicts example architecture 700 for skill-based LLM prompt generation. Requests are received by context mediator 604. These requests may be provided by various applications of a computing platform.

The requests are initially routed to intent identifier 702. This software module may be configured to determine an intent or purpose of requests in order to further route the requests to one or more of skills 704A, 704B, and/or 704C. Such an intent or purpose can be determined programmatically in accordance with a number of techniques.

A rule-based system may use a predefined set of rules and patterns (e.g., patterns of particular words) to match and classify requests. The rules may be designed based on prior knowledge of the expected user inputs and their corresponding intents.

A machine learning classifier may involve training a machine learning model on a labeled dataset of requests and their corresponding intents. The model learns relationships in the data and can generalize to new, unseen requests. Techniques such as logistic regression, support vector machines (SVM), and random forests can be used for intent classification. Additionally, neural network models, such as convolutional neural networks (CNN) or recurrent neural networks (RNN), can be used for intent classification. These models learn hierarchical representations of text and capture contextual information. Architectures like long short-term memory (LSTM) or transformers (e.g., BERT) can be employed in NLP tasks.

A named entity recognition (NER) technique may be used to extract and classify named entities from text, such as names, locations, or dates. By identifying relevant entities in a request, the intent behind the request can be inferred. For example, if a request mentions a specific location, the intent might be related to finding directions or information about that location.

Word embeddings, such as Word2 Vec or GloVe, represent words in a high-dimensional vector space, capturing semantic relationships therebetween. By training a model on a large corpus of text, these embeddings can be used to identify similarities and relatedness between words, aiding in intent classification.

Pre-trained language models like BERT, GPT, or ELMo have been pre-trained on large corpora and can be fine-tuned for specific tasks, including intent classification. These models can understand the context and meaning of words and phrases, allowing them to handle complex queries effectively. In other words (and not explicitly shown in FIG. 7), intent identifier 702 could query LLM service 608 in order to determine the intent of requests. For example, such a query might use the prompt “classify the intent of the request ‘X’ into one or more of the categories ‘A’, ‘B’, or ‘C’.” Here, X may be the text string of the request, and A, B, and C, may be skills supported by context mediator 604.

Regardless, based on the result from intent identifier 702, one or more of skills 704A, 704B, and/or 704C may be selected. Each of skills 704A, 704B, and/or 704C may be a software module specifically configured to interact with LLM service 608 to carry out its respectively identified class of intent. Notably, the ellipsis in FIG. 7 indicates that there may be more than the three skills shown.

As an example, skill 704A may relate to generating charts in the form of user interface components by way of LLM prompts, skill 704B may relate to interpreting charts from user interfaces by way of LLM prompts, and skill 704C may related to determining contextually relevant information from various applications. Other possibilities include skills specific to interacting with particular applications (e.g., an incident management skill), conversing with users via a virtual agent, and so on. In taking any of these steps, the skills may query and/or write to one or more databases, make local or remote API calls, and/or take other actions.

While FIG. 7 only depicts requests being used to generate LLM prompts, information may flow in the opposite direction as well. Thus, LLM responses from LLM service 608 may be provided to a corresponding skill, and the skill may translate at least part of these LLM responses into replies to be transmitted to the requesting application. In some cases, a skill may transmit and receive multiple LLM prompts and LLM responses in various orderings before providing a reply to the requesting application.

### IX. User Interfaces and Components

Graphical user interfaces consist of one or more screens, with each screen including a set of components. Such components may include buttons, non-editable text labels, text boxes (e.g., for text entry by a user), check boxes, radio buttons, drop-down menus or lists, list boxes with selectable list items, sliders, charts, graphs, panels (sections of an interface that may contain other components), progress indicators (e.g., progress bars), menu bars, tool bars, tabbed controls, dialog boxes, scroll bars, image viewers (e.g., a container to display an image or icon), tooltips (e.g., a pop-up box that provides context information when hovered over or actuated), separators, and so on. Some components may serve as containers for other components (e.g., panels as noted above or list boxes containing list items).

This list of components is not comprehensive. More or fewer types of components may be used in various graphical user interfaces. Further, different names may be used to refer to these components (e.g., a panel may also be called a pane, a container, or a box).

Each of these components may have a size (e.g., dimensions in pixels, inches, or centimeters), a position (e.g., defined by the top left corner of the component in either relative or absolute coordinates), one or more colors (e.g., a background color and a foreground color), a style (e.g., a font, font size, and/or or line weight), a visibility (e.g., shown or hidden), validation rules (e.g., for text entry), and/or custom event handling routines or scripts. Other components may have additional characteristics that are hard-coded or configurable.

When arranged on a graphical user interface, these components inherently exhibit a hierarchical structure. For example, the hierarchy may be tree-like, with the screen itself being the root node of the tree and the components being arranged as children of the root node or of other components. Such a tree-like hierarchy can be helpful when representing the components in a data structure, as the data structure encodes the visual layout of the components with respect to one another.

In general, a component is a reusable and modular element that can be embedded into a web-based interface or custom application. It is typically defined using web technologies such as XML, HTML, cascading style sheets (CSS), and/or JavaScript. Components provide a way to encapsulate and package functionality, making it easier to build and maintain complex user interfaces. In addition to being reusable (thus promoting interface consistency and development efficiency), components can be customized, interactively respond to actions or events, and bind to units of data in a data model (e.g., a database) to display and automatically update this data.

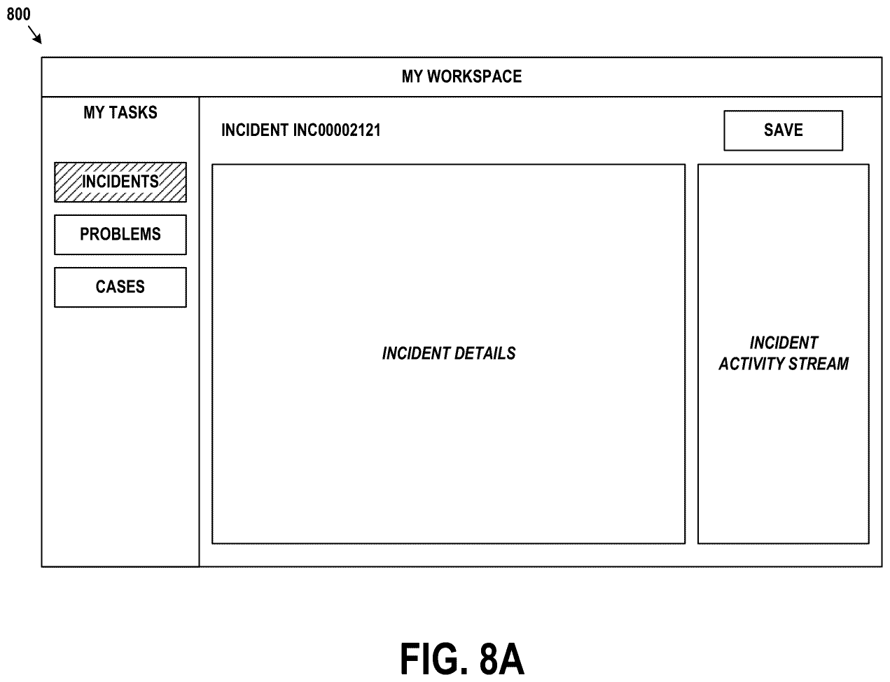

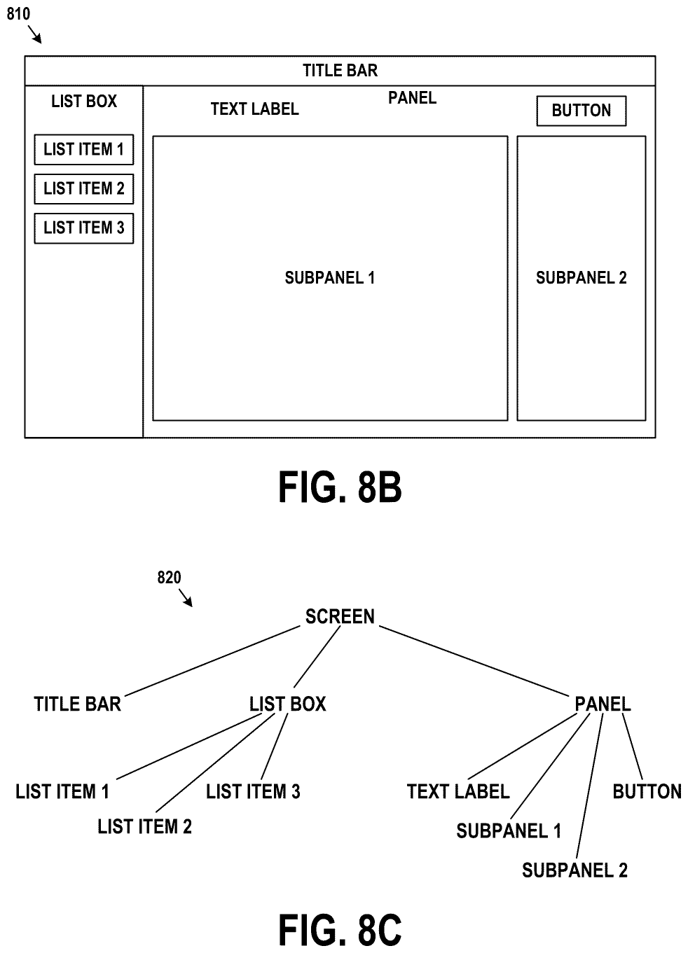

An example of a graphical user interface employing components is shown in FIGS. 8A, 8B, and 8C. This example involves the display of information relating to an incident by an incident management application. Nonetheless, this example is merely for purposes of illustration and other types of graphical user interfaces relating to other types of applications may benefit from the embodiments herein.

In FIG. 8A, example graphical user interface 800 is shown. This graphical user interface includes a title bar (“my workspace”), a list box with list items (“my tasks”), and a panel (to the right of the list box and below the title bar). The panel contains a text label (“Incident INC00002121”), a button (“save”), and two subpanels (one for incident details and the other for an incident activity stream). The “incidents” list item is selected, which causes the panel's contents to be incident-related.

FIG. 8B depicts representation 810 of graphical user interface 800. Representation 810 has the same layout as graphical user interface 800 but labels each component with its component type. FIG. 8C depicts tree-like structure 820 for graphical user interface 600 using the component types named in representation 810. Tree-like structure 820 specifies the hierarchy of the components of graphical user interface 800 and reflects how these components may be arranged in a data structure.

A user can navigate through such a graphical user interface by using any of a number of input modalities, such as by keyboard, pointer (e.g., mouse), touch-based interface, audio command (e.g., voice command), and so on. In general, graphical user interface navigation is event driven, where events can be generated by way of these input modalities (e.g., a keystroke is intercepted and generates an event that is delivered to the graphical user interface controller), or are non-input events (e.g., a timer-related event such as a timer expiry causes part of a graphical user interface to change color, or the result of a remote application programming interface call causes text to be automatically populated in a text box).

A graphical user interface may have a focus, the focus being the component that is currently selected or live for the user and ready to receive input or otherwise be manipulated. For instance, if the user selects a text box component, the text box may be highlighted or emphasized in some fashion to indicate that it has the focus. Then, any text entered by the user would be placed into this text box until the focus changes to a different component (or until the text box is full). It is possible for a graphical user interface to have no focus (e.g., when it is initially loaded).

Notably, each component of a graphical user interface can be represented in a structured format (e.g., XML or JSON). Doing so logically separates the design of the components from the interpretation thereof. In other words, the component defines the structure of the graphical user interface, and its XML or JSON can be interpreted at run time to form a graphical display. Further, components can be nested within other components in accordance with a tree-like structure.

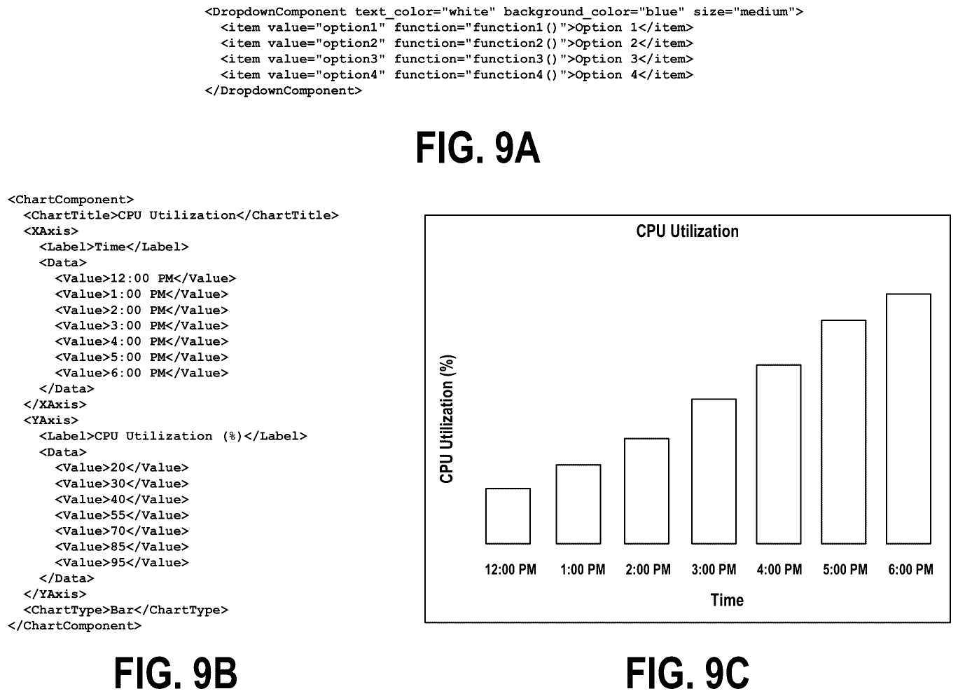

FIG. 9A defines a possible dropdown menu component in XML format. In this example, each <item> tag includes a function attribute that specifies a respective JavaScript function to be called when the corresponding option is selected. The <dropdown> tag includes three additional attributes: text_color, background_color, and size. The text_color attribute is set to “white” to define the text color of the dropdown component, and the background_color attribute is set to “blue” to define the background color of the dropdown component. The size attribute is set to “medium” to define the relative size of the dropdown component.

FIG. 9B defines a possible bar chart component in XML format. In this example, <ChartComponent> is the main container element for the chart, <ChartTitle> represents the title of the chart, which in this case is “CPU Utilization”, <XAxis> defines the X-axis configuration, <YAxis> defines the Y-axis configuration, and <ChartType> specifies the type of chart, which is “Bar” in this case. The X-axis configuration includes <Label>, representing the label for the X-axis, which is “Time”, <Data>, containing the data points for the X-axis, and <Value>, each representing a specific time, ranging from 12:00 PM to 6:00 PM. The Y-axis configuration includes <Label>, representing the label for the Y-axis, which is “CPU Utilization (%)”, <Data>, containing the data points for the Y-axis, and <Value>, each representing specific CPU utilizations.

As described above, such a structured representation of a component can be interpreted into a graphical form. FIG. 9C shows a corresponding rendering of the bar chart defined by the component XML of FIG. 9B.

Putting this together, a graphical user interface can be defined as a tree-like structure of XML-based or JSON-based components, where components can be swapped in and out and rearranged as needed by way of a visual user interface builder application. Nonetheless, the examples provided above are just some ways in which a modular, component-based user interface can be designed and implemented. Other possibilities exist.

### X. Enhanced User Interface Design and Configuration

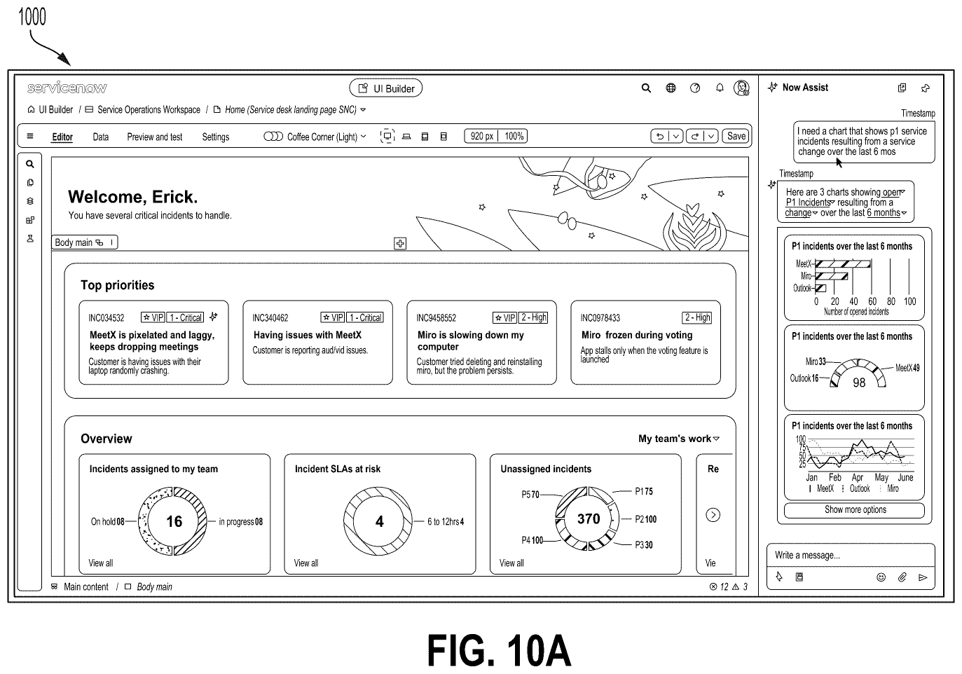

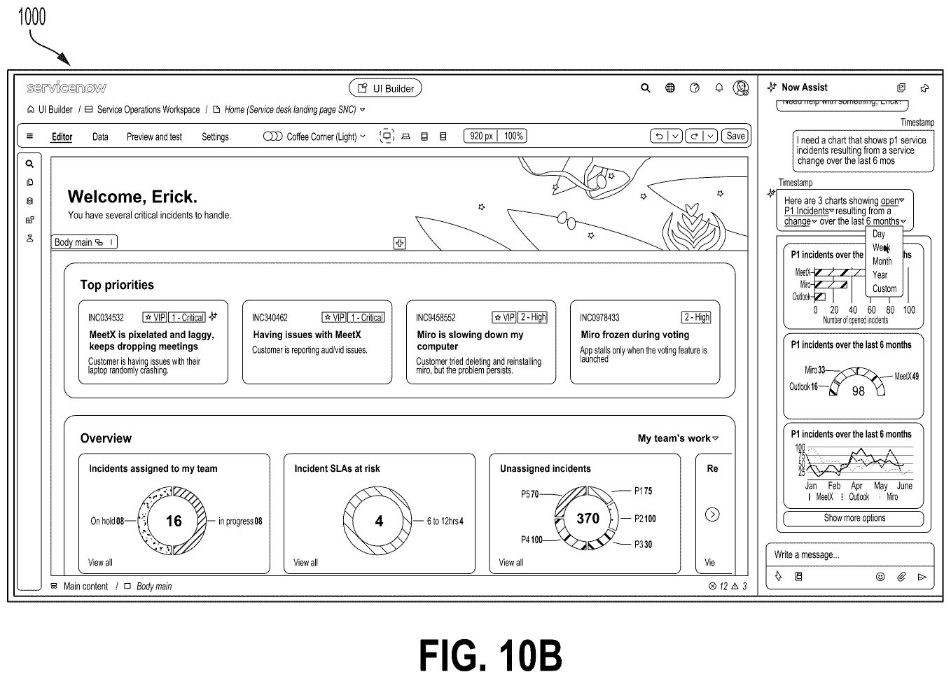

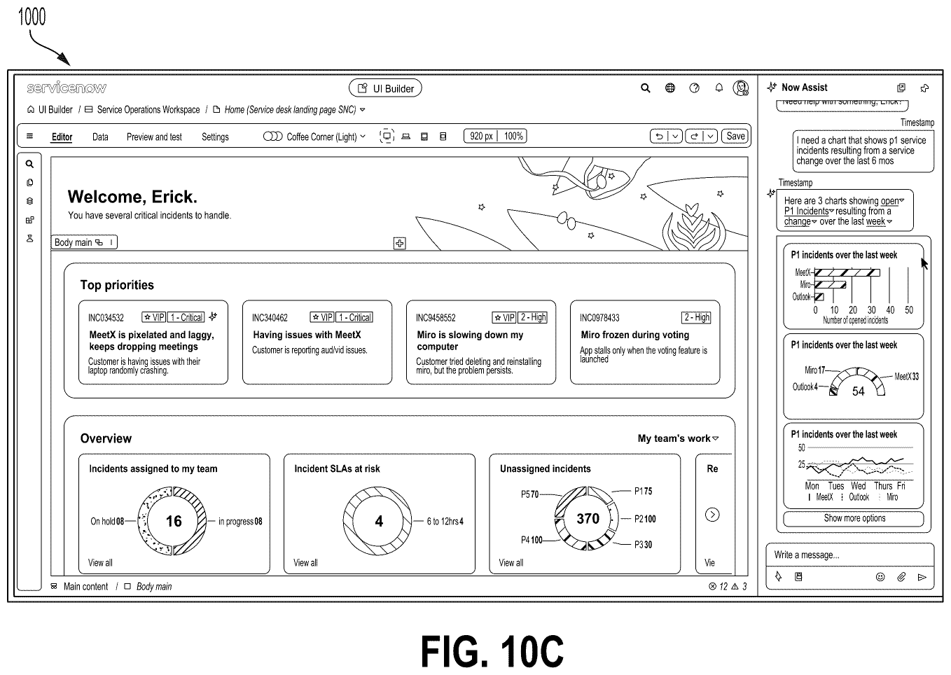

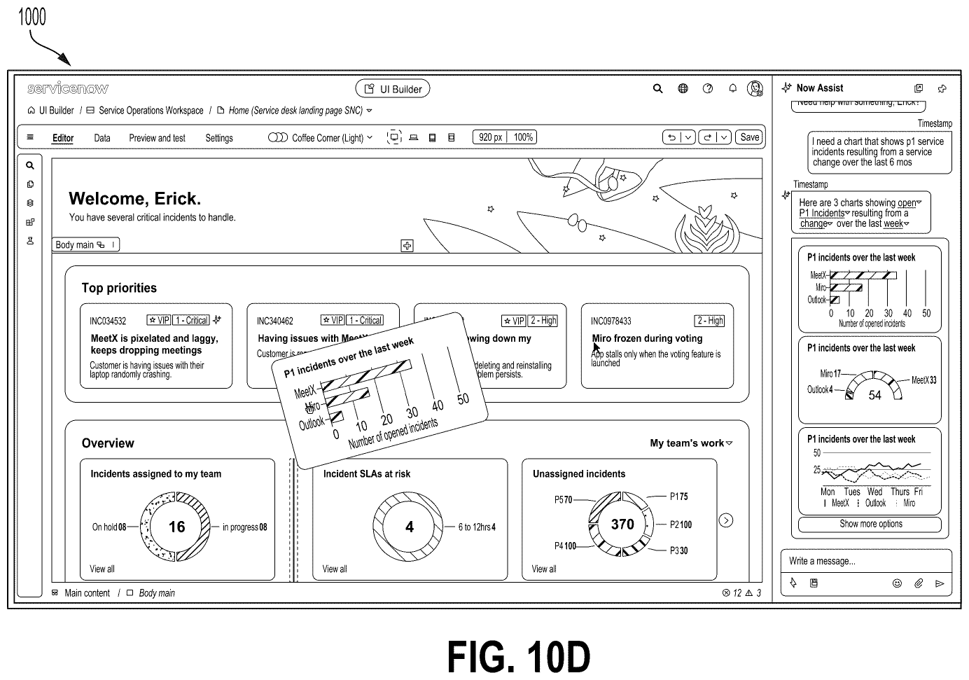

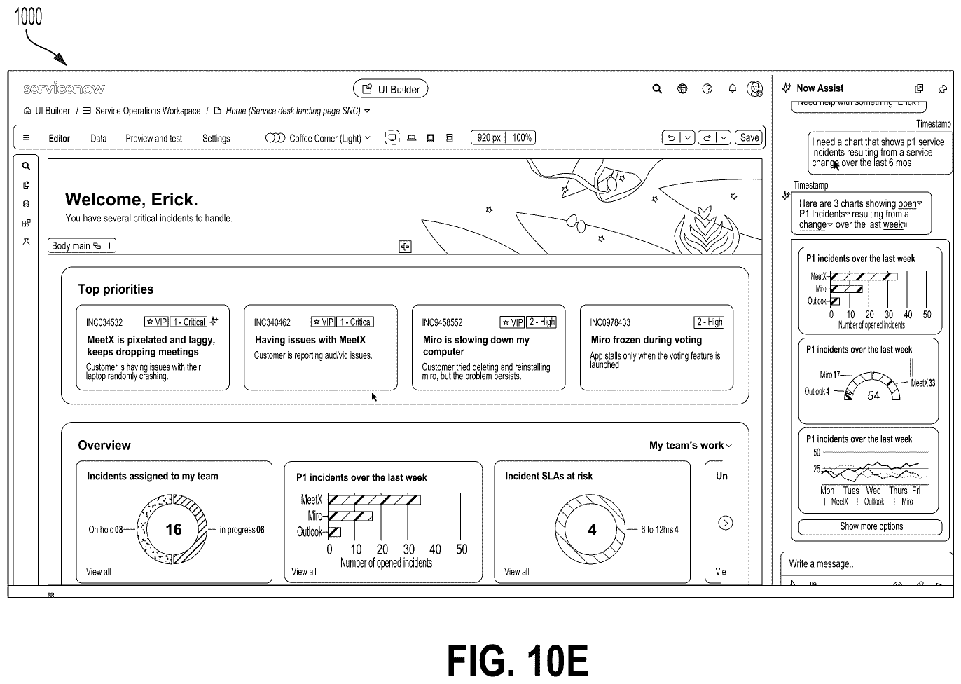

The embodiments herein leverage this modular user interface design and integration with LLMs to facilitate rapid generation and placement of user interface components in a low-code or no-code fashion. An example of this is shown in FIGS. 10A-10E. Notably, FIGS. 10A-10E depict user interfaces that could be displayed on a desktop or laptop computer, for example. These user interfaces may also be adapted for use on mobile interface (e.g., on a mobile phone or a tablet device) that has a smaller screen. Consequently, some components and/or information shown in the user interfaces of FIGS. 10A-10E may be compressed, omitted, rearranged, overlaid, or transformed in some other fashion to comply with usability practices for mobile interfaces.

FIG. 10A depicts graphical user interface 1000 that may be presented to an end user. This user could be an agent tasked with investigating and addressing IT incidents of technology users. Graphical user interface 1000 consists of a number of components, and only the main components will be discussed herein. These include the left panel titled “UI Builder” and the right column titled “Now Assist”. Graphical user interface 1000 may be part of an application that is integrated with an LLM service by way of a context mediator, as described above.

The left panel contains a number of components relating to the user's assigned tasks, including an list of the incidents that are their top priorities (with each incident represented in its own component), and an overview of incident management progress (including a number of charts relating to assigned incidents, service-level agreements (SLAs) at risk due to open incidents, and unassigned incidents).

The right column contains a textual dialog in the form of a chat session between the user and the context mediator. This dialog allows the user to make natural language requests, which are processed by the context mediator and either resolved by the context mediator or passed on to the LLM service in the form of an LLM prompt.

In the example shown in FIG. 10A, the user has entered the dialog text “I need a chart that shows p1 service incidents resulting from a service change over the last 6 mos”. Here it is assumed for sake of simplicity that all incidents related to one of three applications: MeetX, Miro, and Outlook.

The context mediator may determine the intent of this request and make the appropriate queries to one or more database tables in order to gather the raw data for the chart. For example, the context mediator may process the language of the dialog text to determine that the queries should result in incidents that are: p1 (highest priority), relating to a service change, and from the last six months. The context mediator may also infer that only open p1 incidents should be considered, as closed incidents are rarely of interest. The database queries may return counts of such p1 incidents broken down by month and application, for example.

Then, the context mediator may generate an LLM prompt that requests one or more charts of these incidents. As shown in the right column, three proposed charts are provided, a bar chart of total incidents per application, a half-pie chart of total incidents per application, and a line chart of incidents per application per month for the last six months (e.g., January-June). The context mediator may generate these types of charts by default or by taking into account prior user requests. Note that these charts are for purposes of example and therefore may not be in agreement with one another.

The context mediator may specifically generate one LLM prompt per chart with the appropriate raw data included. For example, the following prompt could be used to generate the XML shown in FIG. 9B: “Generate XML representing a bar chart for the following data, where the x axis is time and the y axis is CPU utilization %: [12:00 PM, 1:00 PM, 2:00 PM, 3:00 PM, 4:00 PM, 5:00 PM, 6:00 PM; 20, 30, 40, 55, 70, 85, 95].” With this XML generated and returned to context mediator in an LLM response, the appropriate user interface component can be rendered in-line as shown in the dialog in the right column.

In addition to these proposed charts, the context mediator may also provide, as part of its reply, an interactive unit of dialog. In FIG. 10A, this is “Here are 3 charts showing open p1 incidents resulting from a change over the last 6 months”. Each of the terms open, P1 incidents, change, and 6 months are in the form of a dropdown menu so that they can be easily modified by the user. For example, the user may view the three proposed charts and decide that they would rather consider the same type of incidents, but only over the last week.

FIG. 10B depicts the user actuating this option in the appropriate dropdown menu. FIG. 10C depicts an updated version of graphical user interface 1000 with the right column dialog showing charts of the incidents over the newly-selected time frame of a week. This update may be facilitated by a new request being sent to context mediator, context mediator querying the database for the raw data to fulfill this request, and then the context mediator generating and transmitting one or more LLM prompts with this data to the LLM service. The resulting LLM responses may be used as a basis for rendering the user interface components as shown.

In addition to generating charts with the assistance of the context mediator and an LLM, various implementations may allow the user to drag and drop these generated charts into other parts of the user interface (e.g., from the right column into the left panel). As noted above, the graphical user interface components (including the generated charts) can be represented in a tree-like structure with the focus being on at most one of these components. The user can select one of the generated charts (e.g., with a pointer device such as a mouse), thus giving its component the focus. Then, the user can drag this component to a location in the left panel.

The left panel may represent the dragged component in a manner that makes it clear that the component is not yet part of the left panel (e.g., using different shading, brightness, or colors). The left panel may also indicate which locations or locations are available for dropping the dragged component. Such indications may be based on the tree-like structure of the graphical user interface. When the dragged component is dropped, the tree-like structure is updated accordingly (e.g., a node with the component's XML is moved from one location to another in the tree-like structure).

An example is shown in FIGS. 10D and 10E. Notably, this is just one example and other techniques for placing components may be used.

In FIG. 10D, the component for the proposed chart titled “Pl incidents over the last week” is selected and dragged from the right column to the left panel. Then, based on the location of the user's pointer device, the dragged component is shown near one particular location in which it can be placed. The left panel shows an indication of this location with a vertical line between the two other components titled “Incidents assigned to my team” and “Incident SLAs at risk”. In terms of the tree-like structure, the component with the proposed chart is to be made a sibling node of these two other components.

FIG. 10E shows graphical user interface 1000 updated after the user drops the dragged component into this location. Notably, the dragged component now appears between the components titled “Incidents assigned to my team” and “Incident SLAs at risk”. Doing so may cause the tree-like structure of the graphical user interface to be updated (e.g., the newly-placed component may now be represented as a sibling node to these other components in the tree-like structure).

A number of additional related features that are not explicitly shown in the figures may also be implemented. For example, a user may request modifications to a generated chart shown in the right column before dragging and dropping the component for this chart onto the left panel. These modifications may be set forth in natural language and may be as simple as asking the charts to be generated in different colors or sizes, or with different sets of underlying raw data.

For example, rather than selecting a dropdown option in the right column to change the range of the x-axis, this can be accomplished by the type entering “Generate the same chart but over the last 3 months instead” or “Do it again but for the last three months”. Since some state relating to previous requests may be maintained by the context mediator and/or the LLM service, these modification requests can refer to the results of previous requests and do not need to be complete or standalone. Further, since the requests are interpreted based on an inferred intent, various synonymous natural language text strings can be used to obtain the same result.

Another feature may facilitate the user requesting the addition of data to a chart or the combination of two or more charts. For example, given the generated charts of the right column, the user want to modify these charts to include p2 incidents (where p2 incidents are generally lower priority and/or criticality than p1 incidents). The user may provide a request such as “Please add open p2 incidents resulting from a change to this chart” or “Remake the chart to include p2 incidents.” Similarly, if the user has generated two or more charts, the user may request that the data from these charts be combined into a single chart. For instance, suppose that the user has generated one chart showing p1 incidents and another chart showing p2 incidents over the same time frame. Then, the user may provide a request such as “Combine these two charts into one chart” or “Produce one chart that includes the p1 and p2 data from the previous two charts”.

Yet another feature may be to leverage the ability to drag and drop components in the opposite direction—from the left panel to the right column. Then, the user can enter a request for a plain language explanation of the chart. This can be helpful when the chart is complicated and/or the user is new to the application. Turning to FIG. 10E, the user may select, for example, the component with the chart titled “P1 incidents over the last week” and drag this chart to the right column. In this case, doing so would not remove the chart from the left panel, but instead copy the chart into the dialog of the right column. Then the user could provide a request such as “Explain what this chart means in plain English that a layperson could understand.” The context mediator would receive this request, obtain the raw data underlying the chart from the component, and provide a combination of this input as an LLM prompt. The LLM service may provide a response, such as “This chart shows the number of opened p1 incidents over the last week for MeetX, Miro, and Outlook, with MeetX by far the source of the most incidents.”

As another example of how an LLM might be able to help a user understand a chart, consider the chart of FIG. 9C. Suppose that the raw data underlying this chart is provided to the LLM along with a request or prompt such as “Explain what this chart means in plain English that a layperson could understand”. The LLM may respond with text such as follows:
“This bar chart represents CPU utilization over a period of time. Let's break down the chart. The chart title is “CPU Utilization,” which means it shows how much of the computer's central processing unit (CPU) resources are being used. The x-axis, which is the horizontal axis at the bottom, represents time. It starts at 12:00 PM and ends at 6:00 PM, indicating a six-hour period. The y-axis, which is the vertical axis on the left, represents CPU utilization percentage. It shows the amount of CPU resources being used, ranging from 0% to 100%. The chart consists of vertical bars that represent CPU utilization at different time intervals. Each bar corresponds to a specific time, such as 12:00 PM, 1:00 PM, 2:00 PM, and so on. For example, at 12:00 PM, the bar height is low, indicating that the CPU utilization is around 20%. As we move to 1:00 PM, the bar height increases, indicating higher CPU utilization at around 30%. This trend continues throughout the day, with the bar height increasing gradually until it reaches its highest point of around 95% at 6:00 PM. In simple terms, the chart shows how busy or active the computer's CPU is during the given time period. Higher bars represent a higher level of CPU usage, which may indicate that the computer is processing more tasks or running more demanding programs. By looking at this chart, you can observe how CPU utilization changes over time, providing an understanding of the computer's workload and resource usage during different hours of the day.”

Alternatively or additionally, the user might provide a request or prompt such as “What does it mean for a computing system to exhibit the trend shown in this chart? Explain in plain English.” The LLM may respond with text such as follows:
“If a computing system exhibits the trend shown in this chart, it means that the system's CPU utilization gradually increases throughout the day, reaching its peak by 6:00 PM. The chart indicates that the computing system starts with relatively low CPU usage around 20% at 12:00 PM. As time progresses, more tasks or processes are being executed, causing the CPU utilization to gradually increase. In summary, the trend in this chart shows that the computing system becomes progressively busier as the day goes on, with CPU utilization increasing steadily. The system reaches its busiest state by 6:00 PM, utilizing a significant portion of its processing power.”

If the user is not technically oriented, they may understand that the CPU utilization is following a problematic trend but not know what to do about it. Thus, the user might provide a request or prompt such as “I am not a technical user, what can I do to reduce the CPU utilization on a system exhibiting this trend?” The LLM may respond with text such as follows:
“If you're not a technical user, there are still a few actions you can take to reduce CPU utilization on a system exhibiting a trend of increasing utilization throughout the day. Close Unnecessary Programs: Make sure to close any programs or applications that you're not actively using. This includes web browsers with multiple tabs, media players, or other software that may be running in the background. Restart Your Computer: Restarting your computer can help free up system resources and close any processes that might be causing high CPU utilization. Scan for Malware: Run a reliable antivirus or anti-malware software to scan your system for any potential malware or viruses that could be causing high CPU usage. Remove any threats detected by the scan. Clear Temporary Files: Regularly clear temporary files, cache, and browsing history from your web browser. These files can accumulate over time and impact system performance. Seek Professional Assistance: If you're still experiencing high CPU utilization and are unsure about taking further steps, it might be helpful to consult a technical expert or seek assistance from a computer technician who can provide more personalized guidance. Remember, it's important to be cautious when making any changes to your computer system. If you're unsure about any steps or concerned about potential risks, it's best to consult with a knowledgeable person or professional for assistance.”

In still another feature, the user might request in the dialog of the right column that a dashboard of charts and possibly other information as well in the left panel be explained as a whole. For example, a number of related charts may each provide a snapshot of the performance of a computing system or application, but the overall performance can only be inferred from synthesizing the data in these charts. Such a request or LLM prompt, along with the raw data underlying each of the charts, may be provided to the LLM service so that it generates such a synthesis.

Additional features related to the right column may include the ability for it to be dragged or otherwise moved from its shown location and “float” as its own window atop other portions of user interface 1000. Further, the dialog function of the right column is not limited to text entry and could be drive by voice instead. For instance, the user may speak a command and a speech-to-text conversion application may place a textual version of the speech into the dialog.

Likewise, a text-to-speech conversion application may cause a spoken language version of any text in the card (or a description of an image in the card) to be emitted to the user.

### XI. Enhanced Chat Interfaces

As noted above, a computational instance of a remote network management platform may support conversational interfaces designed to interact with users and provide automated assistance. By way of these interfaces, a human user may obtain technical support from a human agent or virtual agent (possibly enhanced by an LLM), for example. These conversational interfaces may be referred to a chats, chat dialogs, chat applications, messengers, messaging dialogs, or messaging applications for example. Further, they may be web-based, appear in a standalone application, or appear in an application that integrates the conversational interface with other features. They may be constructed from combinations of graphical user interface components, such as those discussed above.

A desirable feature of conversational interfaces the ability to have them provide contextual assistance, in the form of links to other information available by way of the computational instance or other systems. However, this contextual assistance in its current form is rudimentary, based on keyword matching or word/phrase similarity techniques. Moreover, as the dialog progresses, the user may wish to scroll up (or down) to other parts of the dialog. But the contextual assistance is often limited to the most recent units of dialog.

The architecture depicted in FIGS. 6 and 7, and/or variations thereof, may be used to improve upon these conversational features. In particular, context mediator 604 may be used alone or in conjunction with LLM service 608 to provide a contextually relevant listing of information, links, and suggested queries in a sidebar of a chat dialog.

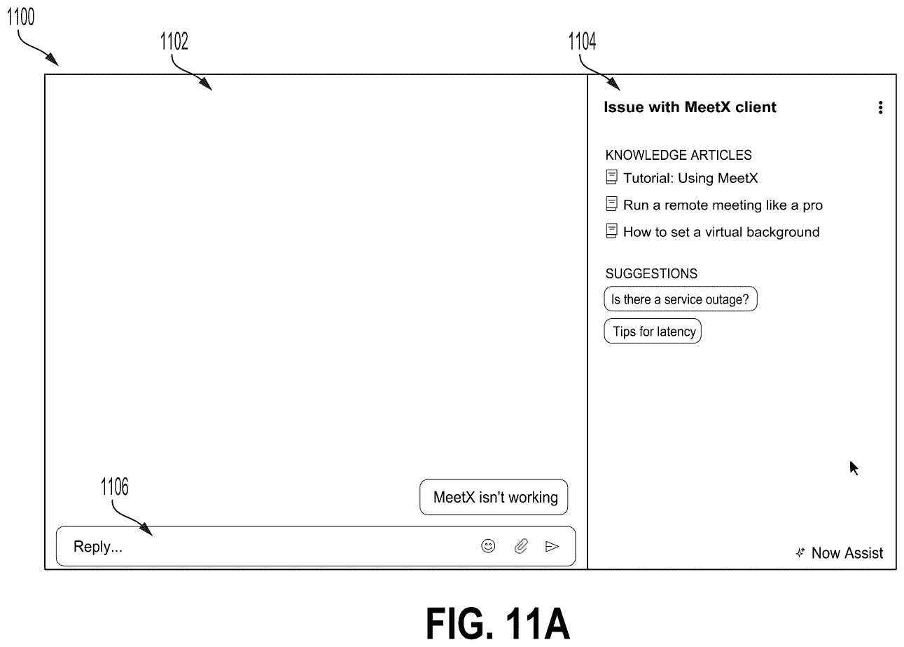

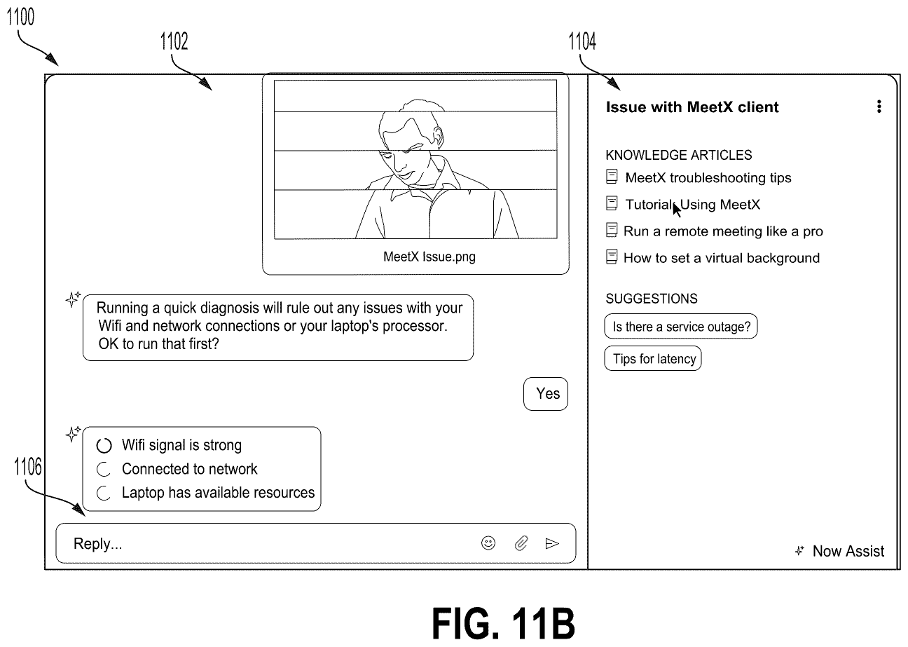

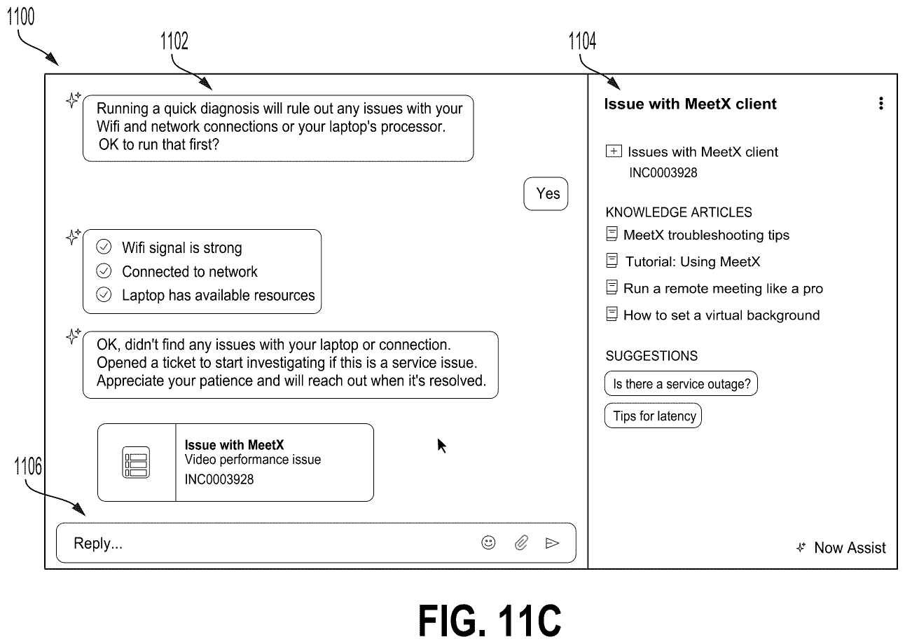

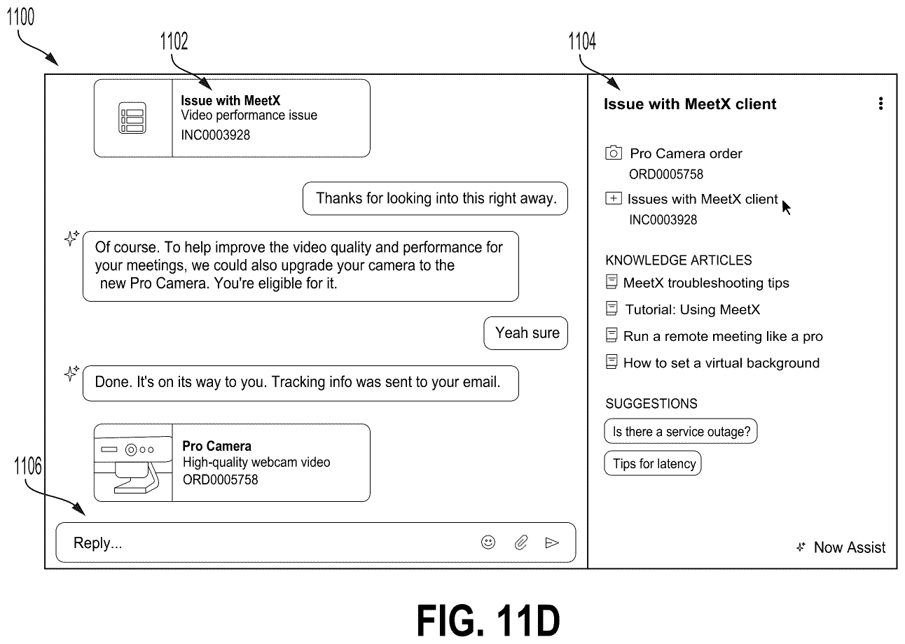

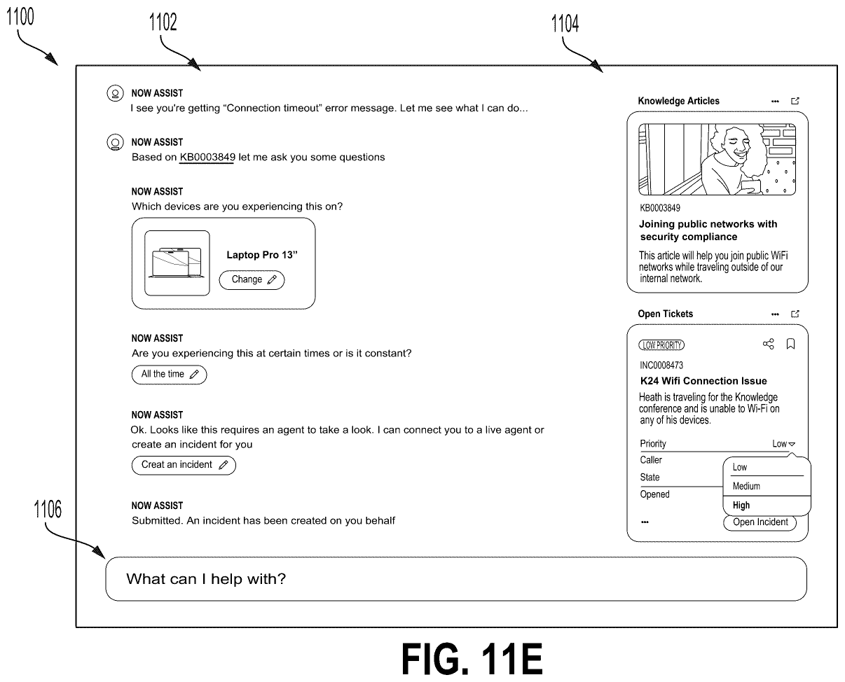

An example is shown in FIG. 11A. As noted, conversational interface 1100 may be web-based, part of a standalone application, or part of an application that integrates the conversational interface with other applications. Conversational interface 1100 includes dialog panel 1102 on its left side and context panel 1104 (or a sidebar) on its right side.

Dialog panel 1102 facilitates real-time communication between the user and another user, a chatbot, or a combination of users and/or chatbots, enabling these entities to exchange messages, queries, and responses. For example, the user may type a textual message into text box 1106 at the bottom of dialog panel 1102 (the user may also be able to insert graphics, audio, video, and/or emojis into text box 1106). Alternatively, the user may employ voice recognition so that the conversational interface facilitates transcription of the user's spoken words into text box 1106.

Once the user indicates that the message should be sent (e.g., by actuating the “enter” key on a keyboard or by way of a pointing device), the message becomes part of the running dialog between the users and the other entities (i.e., the message is sent to each of the other entities) appearing in dialog panel 1102. Responses from the other entities appear below the message, as the conversational interface causes previous messages to scroll up so that the most recent message is at the bottom of the dialog in dialog panel 1102. In FIG. 11A, the dialog consists of just one message, from a user to human or virtual agent, indicating that the user's MeetX application (a video conferencing application) is not working.

Context panel 1104 provides one or more lists of information that are determined to be contextually relevant to the semantic meaning of at least some messages of the dialog in dialog panel 1102. These lists may be updated dynamically, for example after each message is added to the dialog in dialog panel 1102. In FIG. 11A, context panel 1104 contains two lists. The upper list is of knowledgebase articles that are deemed to be relevant to the dialog in dialog panel 1102 as a series of links. The user can actuate (e.g., select or click on) any of these links to view the associated article (e.g., in a web browser). The lower list contains suggestions of messages that the user can add to the dialog in dialog panel 1102.

The system may determine the knowledgebase articles to provide in various ways. For example, a similarity model (e.g., using word vectors, paragraph vectors, or transformers) may be used by the context mediator to match the message “MeetX isn't working” with the three knowledgebase articles shown. Doing so might not require invocation of the LLM service. On the other hand, the LLM service may be trained with a set of knowledgebase articles and thus be able to identify which are deemed to be the most contextually relevant. In this case, an LLM prompt may take the form of “Recommend one or more knowledgebase articles relevant to ‘MeetX isn't working’.” Alternatively, the context mediator may provide a list of the titles of knowledgebase articles to the LLM service, and ask that the LLM service provide a list of the most relevant. Here, an LLM prompt may take the form of “Recommend one or more knowledgebase articles relevant to ‘MeetX isn't working’ from this list [ . . . ]”. Here, the “[ . . . ]” may be replaced by the list of article titles. Other possibilities exist.

The system may also determine the suggested messages in various ways. In one example, the context mediator provides the most recent message or messages to the LLM service in an LLM prompt that asks for relevant follow-up messages. For instance, the LLM prompt may be “Provide one or more self-help messages that a user can send in a chat dialog in which the user has stated ‘MeetX isn't working’.” The LLM service may reply with the suggestions shown “Is there a service outage?” and “Tips for latency”. These suggestions are in the form of user interface pills that can be actuated like buttons or dragged and dropped into text box 1106 in order to have their associated text added to the dialog in dialog panel 1102. In some cases, the skill-based enhancements described above may be used, for example to recognize an intent based on progress through a workflow.

FIG. 11B depicts the conversational interface 1100 after several more messages have been exchanged between the user and the agent. The agent may have asked for more detail about the problems that the user is experiencing with MeetX, and the user may have indicated that its video is pixelated and lags, with the user getting dropped from the conferencing sessions. The agent then asks the user to provide an image of the user's screen, which is at the top of the dialog in dialog panel 1102. The agent responds by performing a remote diagnosis on the user's Wifi connection and processor resources.

Each of these messages may be provided to the context mediator, which may further prompt the LLM service for related knowledgebase articles and suggestions. As shown in FIG. 11B, a knowledgebase article entitled “MeetX troubleshooting tips” has been identified either by the context mediator or LLM service, and has been added to the list of knowledgebase articles shown in context panel 1104.

FIG. 11C depicts the conversational interface 1100 after the agent has sent another message to the user indicating that an incident has been opened relating to the issues experienced by the user with the MeetX application. A link to the incident has been added to the dialog in dialog panel 1102. Information relating to this incident (e.g., the link) can also be provided to the context mediator, which can add the link (with title and incident number) to context panel 1104 in the manner shown or some other manner.

FIG. 11D depicts the conversational interface 1100 after the agent has sent another message to the user suggesting that the user may benefit from obtaining an upgraded camera. The user agrees and the agent places an order for the camera. A link to the order has been added to the dialog in dialog panel 1102. Information relating to this order (e.g., the link) can also be provided to the context mediator, which can add the link (with title and order number) to context panel 1104 in the manner shown or some other manner.

In this manner, the context associated with a dialog can be updated dynamically as the dialog progresses. The context mediator may invoke the LLM service only as needed. For example, adding the links to the incident and the order may not require the language capabilities of the LLM service, but populating the list of knowledgebase articles and suggestions may benefit from assistance from the LLM service.

Additionally, and not shown in FIGS. 11A-11D, information displayed in context panel 1104 may be removed if it is deemed to be no longer of threshold relevance to the most recent message or messages in dialog panel 1102. For example, only the top n (e.g., 2, 3, 5, 10) knowledgebase articles or suggestions that are deemed most relevant to the current dialog might be displayed. This implies that what is displayed in context panel 1104 may change, perhaps significantly, as the dialog evolves. For example, as new messages are added to the dialog, the most recent message or messages may be used to request relevant articles or suggestions from the context mediator and/or the LLM service.

Further, and also not shown in FIGS. 11A-11D, dialog panel 1102 may include a scroll bar that allows the user to scroll up and down through the dialog. This act of scrolling may also cause what is displayed in context panel 1104 to change based on the messages that are displayed in dialog panel 1102. For example, if the user scrolls up in dialog panel 1102 from what is displayed in FIG. 11D to what is displayed in FIG. 11B, the links to the incident and the order may be removed from context panel 1104. Conversely, if the user scrolls down in dialog panel 1102 from what is displayed in FIG. 11B to what is displayed in FIG. 11D, the links to the incident and the order may be added to context panel 1104. This allows the user to pick up where they left off in earlier parts of the dialog by providing the contextualized information.

In order to avoid frequent invocations of the LLM service as the user scrolls, the context mediator may contain a cache of mappings between message(s) and information to display in context panel 1104. As the user scrolls up and down, the message(s) displayed in dialog panel 1102 may be used to look up, in the cache, the appropriately information to display in context panel 1104 without having to send further prompts to the LLM service. Doing so maintains computational efficiency by not requiring the LLM to perform computations that it recently performed.

These features amount to the “best of both worlds” in terms of human-computer interaction. The user gets to have a human-like integration with a computer, but with the ability of a computer to provide and store contextually relevant information with actuatable links and buttons that can be used as part of the ongoing interaction.

FIG. 11E depicts another example of a chat dialog with context panel 1104. But, in this case, context panel 1104 contains one or more cards that are independently and dynamically updatable.

Cards that appear in user interfaces, such as the user interface of FIG. 11E, may be self-contained components designed to display and organize information in a visually appealing and easily digestible format. Each card may include a container with a defined structure that includes elements such as a header, body, and/or footer. The header may contain a title or an image that provides a visual cue to the content within the card. The body is the main area where the bulk of the information is displayed, which can include text, images, buttons, and other user interface components. The footer may contain additional actions or metadata related to the card content, such as timestamps, author information, or interactive elements like buttons or links.

As text or other information is added to text box 1106, cards may be added to or removed from context panel 1104 and/or the content displayed by these cards may change. As shown in FIG. 11E, the content of the chat conversation displayed in dialog panel 1102 causes two contextually relevant cards to appear in context panel 1104. The top card titled “Knowledge Articles” appears first, e.g., in response to the user of conversational interface 1100 reporting a problem accessing a Wifi network. This card contains an image and text relating to a knowledge base article that is intended to help users access Wifi networks.

As the chat in dialog panel 1102 continues, the user requests creation of an incident to track and manage their issue. This results in the bottom card in context panel 1104 appearing. The bottom card has the title “Open Tickets” and contains information relating to the newly-created incident. Notably, a title, brief description, priority, caller, state, and opened fields of the incident are shown.

Some of these fields may be dynamically adjustable by way of the user interface. As an example, FIG. 11E shows a popup menu appearing when the user actuates the arrow to the right of the priority designation. This popup menu allows the user to change the priority of the incident from “low” to “medium” or “high”. Other interactions with cards are possible. Each dynamic adjustment may involve querying a database and receiving results that are used as the basis of the dynamic adjustment, and/or interacting with a natural language model and receiving results that are used as the basis of the dynamic adjustment.

Notably, FIGS. 11A-11E depict user interfaces that could be displayed on a desktop or laptop computer, for example. These user interfaces may also be adapted for use on mobile interface (e.g., on a mobile phone or a tablet device) that has a smaller screen. Consequently, some components and/or information shown in the user interfaces of FIGS. 11A-11E may be compressed, omitted, rearranged, overlaid, or transformed in some other fashion to comply with usability practices for mobile interfaces.

### XII. Example Operations

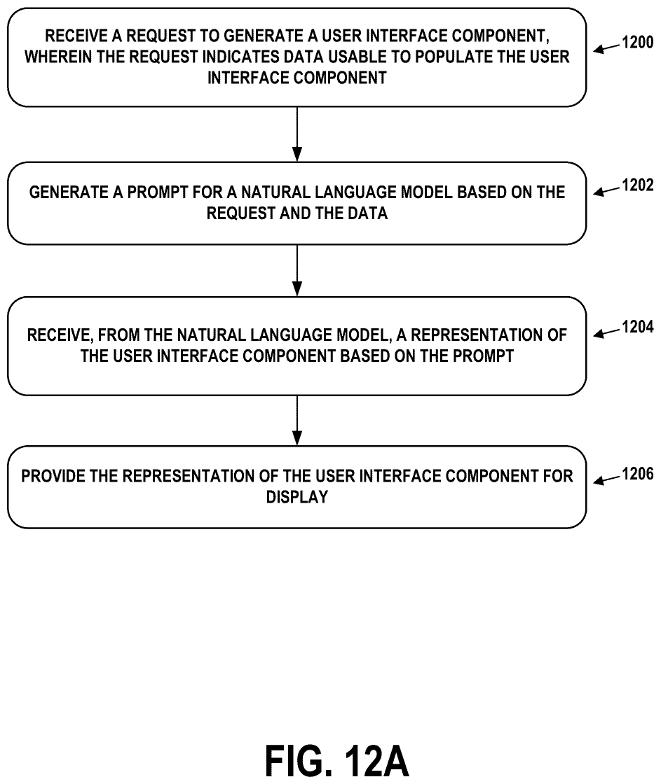

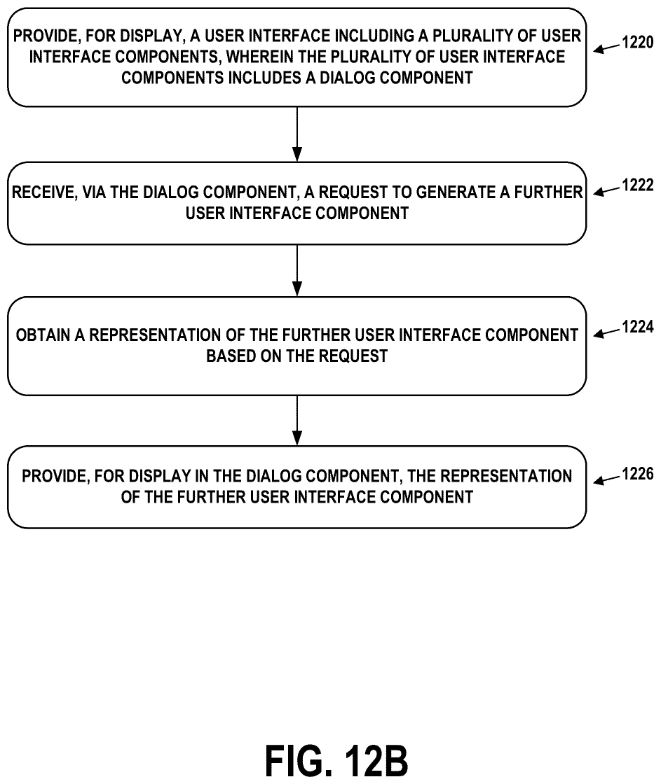

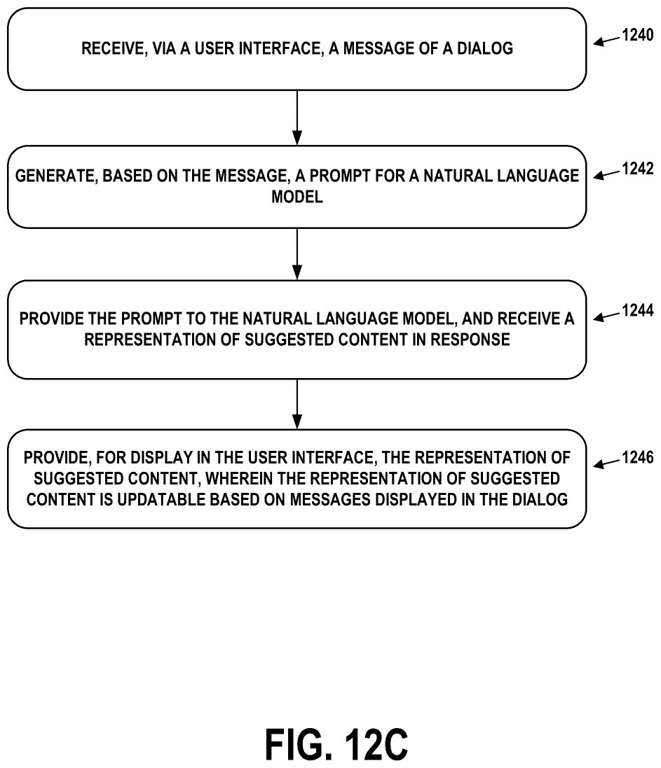

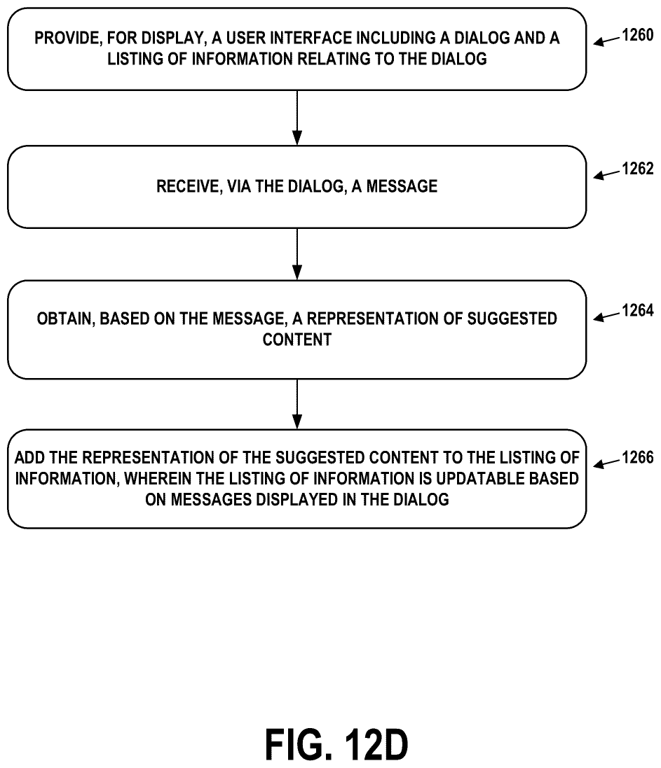

FIGS. 12A-12D are flow charts illustrating example embodiments. The processes illustrated by FIGS. 12A-12D may be carried out by a computing device, such as computing device 100, and/or a cluster of computing devices, such as server cluster 200. However, the processes can be carried out by other types of devices or device subsystems. For example, the processes could be carried out by a computational instance of a remote network management platform or a portable computer, such as a laptop or a tablet device.

The embodiments of FIGS. 12A-12D may be simplified by the removal of any one or more of the features shown therein. Further, these embodiments may be combined with features, aspects, and/or implementations of any of the previous figures or otherwise described herein.

Block 1200 of FIG. 12A may involve receiving a request to generate a user interface component, wherein the request indicates data usable to populate the user interface component.

Block 1202 may involve generating a prompt for a natural language model based on the request and the data.

Block 1204 may involve receiving, from the natural language model, a representation of the user interface component based on the prompt.

Block 1206 may involve providing the representation of the user interface component for display.

In some examples, the request includes the data usable to populate the user interface component.

In some examples, the representation of the user interface component as displayed can be integrated into a larger user interface.

In some examples, receiving the representation of the user interface component based on the prompt comprises receiving a plurality of different representations of the user interface component based on the prompt.

In some examples, providing the representation of the user interface component for display comprises providing the representation of the user interface component for display in a dialog box.

In some examples, the representation of the user interface component is encoded in extensible Markup Language, JavaScript Object Notation, HyperText Markup Language, or Yet Another Markup Language.

In some examples, the natural language model is a transformer-based language model.

In some examples, providing the representation of the user interface component for display comprises providing a description of the representation in a text string with an adjustable option. These examples may further involve: receiving a further request to generate a further user interface component, wherein the further request indicates further data usable to populate the further user interface component, and wherein the further request is based on a selected value for the adjustable option; generating a further prompt for the natural language model based on the further request and the further data; receiving, via the natural language model, a further representation of the further user interface component based on the further prompt; and providing the further representation of the further user interface component for display.

Some examples may further involve: receiving a further request to describe a further user interface component, wherein the further request indicates further data used to populate the further user interface component; generating a further prompt for the natural language model based on the further request and the further data; receiving, via the natural language model, a description of the further user interface component; and providing the description of the further user interface component for display.

Block 1220 of FIG. 12B may involve providing, for display, a user interface including a plurality of user interface components, wherein the plurality of user interface components includes a dialog component.

Block 1222 may involve receiving, via the dialog component, a request to generate a further user interface component.

Block 1224 may involve obtaining a representation of the further user interface component based on the request.

Block 1226 may involve providing, for display in the dialog component, the representation of the further user interface component.

In some examples, the further user interface component is manipulatable into a location among the plurality of user interface components.

Some examples may further involve: receiving a command to copy or move the further user interface component to the location; and copying or moving the further user interface component to the location in response to the command.

Some examples may further involve: receiving a command to drag and drop the further user interface component to the location; and visually dragging and dropping the further user interface component to the location in response to the command.

In some examples, reception of the request causes: obtaining data usable to populate the further user interface component from a database; and generating a prompt for a natural language model based on the request and the data.

In some examples, obtaining the representation of the further user interface component based on the request comprises determining, via the natural language model, the representation of the further user interface component based on the prompt.

In some examples, the natural language model is a transformer-based language model.

In some examples, obtaining the representation of the further user interface component based on the request comprises obtaining representations of a plurality of user interface components based on the request, and wherein providing, for display in the dialog component, the representation of the further user interface component comprises providing, for display in the dialog component, the representations of the plurality of user interface components.

In some examples, the representation of the further user interface component is encoded in extensible Markup Language, JavaScript Object Notation, HyperText Markup Language, or Yet Another Markup Language.

Block 1240 of FIG. 12C may involve receiving, via a user interface, a message of a dialog.

Block 1242 may involve generating, based on the message, a prompt for a natural language model.

Block 1244 may involve providing the prompt to the natural language model, and receiving a representation of suggested content in response.

Block 1246 may involve providing, for display in the user interface, the representation of suggested content, wherein the representation of suggested content is updatable based on messages displayed in the dialog.

In some examples, the suggested content comprises links to one or more documents or suggestions of further messages.

In some examples, the representation of suggested content is provided in a listing of information positioned adjacent to the dialog, wherein the listing of information is updatable based on messages displayed in the dialog.

In some examples, at least some of the suggested content is manipulatable into the dialog.

Some examples may further involve: storing, in a cache, associations between messages of the dialog and corresponding representations of suggested content; and in response to a user interface event involving a change to the messages of the dialog being displayed, updating, from the cache, the representations of suggested content displayed to be those associated with the messages of the dialog being displayed.

In some examples, the user interface event is a scrolling event that resulted in the change to the messages of the dialog being displayed.

In some examples, updating, from the cache, the representations of suggested content displayed to be those associated with the messages of the dialog being displayed comprises updating the representation of suggested content displayed without providing a further prompt to the natural language model to receive further suggested content.

Some examples may further involve: determining that a further message of the dialog refers to an item in a workflow of a task-based application; and providing, for display in the user interface as part of the suggested content, a further representation of the item.

Block 1260 of FIG. 12D may involve providing, for display, a user interface including a dialog and a listing of information relating to the dialog.

Block 1262 may involve receiving, via the dialog, a message.

Block 1264 may involve obtaining, based on the message, a representation of suggested content.

Block 1266 may involve adding the representation of the suggested content to the listing of information, wherein the listing of information is updatable based on messages displayed in the dialog.

In some examples, obtaining, based on the message, the representation of suggested content comprises: generating, based on the message, a prompt for a natural language model; and providing the prompt to the natural language model, and receiving the representation of suggested content in response.

In some examples, the suggested content comprises links to one or more documents or suggestions of further messages.

In some examples, the listing of information is positioned adjacent to the dialog.

In some examples, at least some of the suggested content is manipulatable into the dialog.

Some examples may involve, in response to a user interface event involving a change to messages of the dialog being displayed, updating the listing of information displayed to be associated with the messages of the dialog being displayed.

In some examples, the user interface event is a scrolling event that resulted in the change to the messages of the dialog being displayed.

Some examples may involve: determining that a further message of the dialog refers to an item in a workflow of a task-based application; and providing, for display in the user interface as part of the listing of information, a further representation of the item.

### XIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a request to generate a user interface component, wherein the request indicates data usable to populate the user interface component;
generating a prompt for a natural language model based on the request and the data;
receiving, from the natural language model, a representation of the user interface component based on the prompt; and
providing the representation of the user interface component for display.

2. The method of claim 1, wherein the request includes the data usable to populate the user interface component.

3. The method of claim 1, wherein the representation of the user interface component as displayed can be integrated into a larger user interface.

4. The method of claim 1, wherein receiving the representation of the user interface component based on the prompt comprises receiving a plurality of different representations of the user interface component based on the prompt.

5. The method of claim 1, wherein providing the representation of the user interface component for display comprises providing the representation of the user interface component for display in a dialog box.

6. The method of claim 1, wherein the representation of the user interface component is encoded in extensible Markup Language, JavaScript Object Notation, HyperText Markup Language, or Yet Another Markup Language.

7. The method of claim 1, wherein the natural language model is a transformer-based language model.

8. The method of claim 1, wherein providing the representation of the user interface component for display comprises providing a description of the representation in a text string with an adjustable option, the method further comprising:
receiving a further request to generate a further user interface component, wherein the further request indicates further data usable to populate the further user interface component, and wherein the further request is based on a selected value for the adjustable option;
generating a further prompt for the natural language model based on the further request and the further data;
receiving, from the natural language model, a further representation of the further user interface component based on the further prompt; and
providing the further representation of the further user interface component for display.

9. The method of claim 1, further comprising:
receiving a further request to describe a further user interface component, wherein the further request indicates further data used to populate the further user interface component;
generating a further prompt for the natural language model based on the further request and the further data;
receiving, from the natural language model, a description of the further user interface component; and
providing the description of the further user interface component for display.

10. A method comprising:
receiving, via a user interface, a message of a dialog;
generating, based on the message, a prompt for a natural language model;
providing the prompt to the natural language model, and receiving a representation of suggested content in response; and
providing, for display in the user interface, the representation of suggested content, wherein the representation of suggested content is updatable based on messages displayed in the dialog.

11. The method of claim 10, wherein the suggested content comprises links to one or more documents or suggestions of further messages.

12. The method of claim 10, wherein the representation of suggested content is provided in a listing of information positioned adjacent to the dialog, and wherein the listing of information is updatable based on messages displayed in the dialog.

13. The method of claim 10, wherein at least some of the suggested content is manipulatable into the dialog.

14. The method of claim 10, further comprising:
storing, in a cache, associations between messages of the dialog and corresponding representations of suggested content; and
in response to a user interface event involving a change to the messages of the dialog being displayed, updating, from the cache, the representations of suggested content displayed to be those associated with the messages of the dialog being displayed.

15. The method of claim 14, wherein the user interface event is a scrolling event that resulted in the change to the messages of the dialog being displayed.

16. The method of claim 14, wherein updating, from the cache, the representations of suggested content displayed to be those associated with the messages of the dialog being displayed comprises updating the representation of suggested content displayed without providing a further prompt to the natural language model to receive further suggested content.

17. The method of claim 10, further comprising:
determining that a further message of the dialog refers to an item in a workflow of a task-based application; and
providing, for display in the user interface as part of the suggested content, a further representation of the item.

18. A non-transitory computer-readable medium, having stored thereon program instructions that, upon execution by a computing system, cause the computing system to perform operations comprising:
receiving a request to generate a user interface component, wherein the request indicates data usable to populate the user interface component;
generating a prompt for a natural language model based on the request and the data;
receiving, from the natural language model, a representation of the user interface component based on the prompt; and
providing the representation of the user interface component for display.

19. The non-transitory computer-readable medium of claim 18, wherein receiving the representation of the user interface component based on the prompt comprises receiving a plurality of different representations of the user interface component based on the prompt.

20. The non-transitory computer-readable medium of claim 18, wherein providing the representation of the user interface component for display comprises providing the representation of the user interface component for display in a dialog box.
